(19) United States
(12) Patent Application Publication
(10) Pub. No.: US 2008/0060586 A1
(43) Pub. Date: Mar. 13, 2008

(54) Portable and adaptable animal cage, crate, kennel and mat air conditioning device: Kool Kennel & Kool Kushion

(76) Inventors: George K. Lewis JR., Andover, MA (US); Laurence F. Sanford, Tewksbury, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/895,385

(22) Filed: Aug. 24, 2007

Related U.S. Application Data
(60) Provisional application No. 60/839,575, filed on Aug. 24, 2006.
(60) Provisional application No. 60/899,250, filed on Feb. 2, 2007.

(51) Int. Cl. A01K 1/02; A01K 29/00

(52) U.S. Cl. 119/500; 119/28.5

(57) ABSTRACT

Animal health and wellbeing is of significance to our society, whether the animal is wild or domesticated. Many humans have practiced methods to secure animal interests in both their natural habitats and in modern day society/homes. The presented device is designed around these principles for the wellbeing and humane treatment of the animal, while it is being caged, crated, and/or kenneled. The invention is a portable unit that may be added/attached universally to the outside of any cage, crate, kennel or specialized porous animal pad, and provide air conditioning for the animal within the enclosure. The invention is powered by either a DC or AC supply, so it may be used in the home and on the road. The complete device conceived as “Kool Kennel” and/or “Kool Kushion”, consists of a thermoelectric Peltier Module used for cooling and/or heating the ambient air “The KK Module” along with various air diffusers to connect the regulated air to the animal crate or pad. The KK Module and air diffusers comes with Velcro mounting brackets, and a flexible insulating enclosure covering, to prevent heat exchange between the animal enclosure and surroundings.

### RELATED APPLICATION(S)

This application claims the benefit of U.S. Provisional Application No. 60/839,575, filed on Aug. 24, 2006, entitled “Portable and Adaptable Animal Cage, Crate and Kennel Air Conditioning Device: KOOL KENNEL,” and U.S. Provisional Application No. 60/899,250, filed on Feb. 2, 2007, entitled “Portable and Adaptable Animal Cage, Crate, Kennel and Mat Air Conditioning Device: KOOL KENNEL & KOOL KUSHION.” The entire teachings of the above application(s) are incorporated herein by reference.

### BACKGROUND OF THE INVENTION

Pets are often kept in cages, crates and kennels when traveling with their owners to protect both the pet and the general public. Kennels or crates are also used to store pets when in stationary locations away for their home. For example, it is common for pets to be stored in a crate or kennel for significant periods of time while at events such as the numerous dog shows that occur throughout the country. Due to space limitations in the venues where the shows are held, kennels are often stored in close proximity in areas with less than ideal air temperature control. These environmental conditions may result in excessively high temperatures that may be hazardous to the pets. The ability to protect pets from excessive temperature extremes would be beneficial to the pet's health as well as their owner's well being.

### SUMMARY OF THE INVENTION

An apparatus to provide conditioned air to an enclosure adapted to house a pet according to an example embodiment of the invention may include a cushion adapted to fit into in the base of a pet enclosure. The cushion may have a ventilation layer within a substantially air-tight compartment having an inlet duct for accepting airflow into the ventilation layer and a plurality of outlet openings for exhausting conditioned air to the cushion surface. The example apparatus may include a portable air conditioning unit that has an air intake port, a thermoelectric module, an exhaust port, and a fan positioned to move air from the intake port, across the thermoelectric module, and out the exhaust port. The example apparatus may further include an air diffuser coupled between the exhaust port and the cushion inlet duct so that conditioned air is delivered to the cushion's outlet openings, and a power supply unit configured to provide power to the thermoelectric module and the fan.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a drawing illustrating a portable Air Conditioning (AC) unit and a variety of air diffusers according to an example embodiment of the invention.

FIG. 2 is a drawing illustrating the portable AC unit air diffusers of FIG. 1 shown from a different angle according to an example embodiment of the invention.

FIG. 3 is a drawing illustrating a portable AC unit and an air diffusing pad according to an example embodiment of the invention.

FIG. 4 is a drawing illustrating the portable AC unit diffusing cushion shown from a different angle according to an example embodiment of the invention.

FIG. 5 is a drawing illustrating an example embodiment of the invention as attached to an animal enclosure or as attached to a ventilated cushion.

FIG. 6 is a drawing illustrating the invention of FIG. 5 shown from a different angle according to an example embodiment.

FIG. 7 is a drawing illustrating an example embodiment of the invention employing a thermal cover to prevent heat or cooling loss or gain.

FIG. 8 is a drawing illustrating an example embodiment of the invention and thermal cover of FIG. 7 shown from a different angle.

FIG. 9 is mechanical diagram of an AC unit with labeled parts according to an example embodiment of the invention.

FIGS. 10A and 10B are electrical diagrams of an example embodiment of the invention.

FIG. 11 is diagram depicting an interior view of an air diffusing pad according to an example embodiment of the invention.

FIGS. 12, 13, and 14 illustrate alternative example embodiments of a portable AC unit.

FIG. 15 is a drawing illustrating example embodiments of power sources for powering the portable AC unit.

### DETAILED DESCRIPTION OF THE INVENTION

A description of example embodiments of the invention follows.

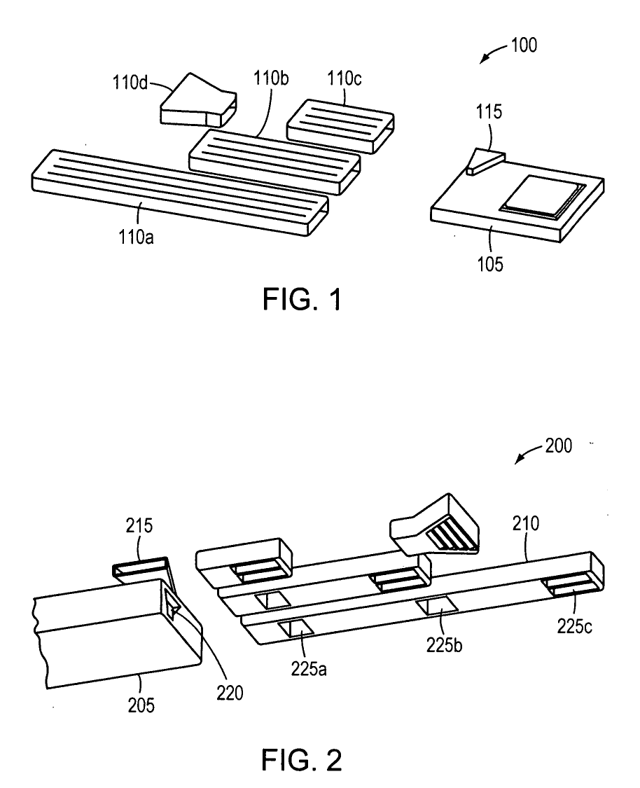

FIGS. 1 and 2 illustrate a Kool Kennel™ portable Air Conditioning (AC) unit 100, 200 according to an example embodiment of the present invention. (Kool Kennel™ is a trademark of Kool Kennel, LLC. of Tewksbury, Mass.) The Kool Kennel™ (KK) module 100, 200 is a stand-alone air conditioning (AC) device that may be attached to or hung from a pet enclosure (not shown) without modifying the enclosure itself.

In the example embodiment, the portable AC unit 100, 200 may comprise an AC module 105, 205 and an air diffuser 10a-c, 210. Air enters the portable AC unit 105, 205 via an intake duct 115, 215 and exits via an exhaust duct 220. The air diffuser 110a-c, 210 may be constructed in a variety of shapes and lengths and is coupled to the exhaust duct 220 such that conditioned air flows from the exhaust duct 220 through the air diffuser 110a-c, 210 and out at least one exhaust port 225a-c. Alternatively, the portable AC unit 105, 205 may be used alone (i.e., without the air diffuser 110a-c, 210).

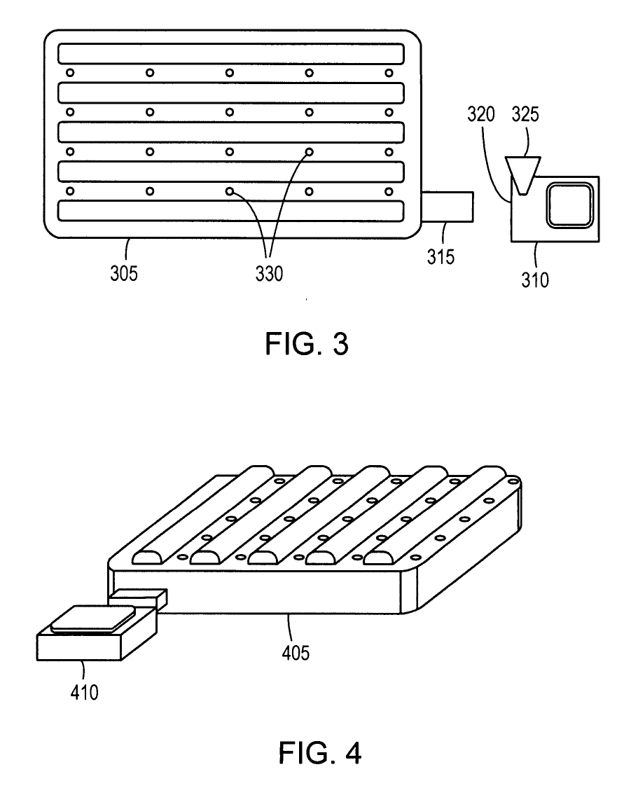

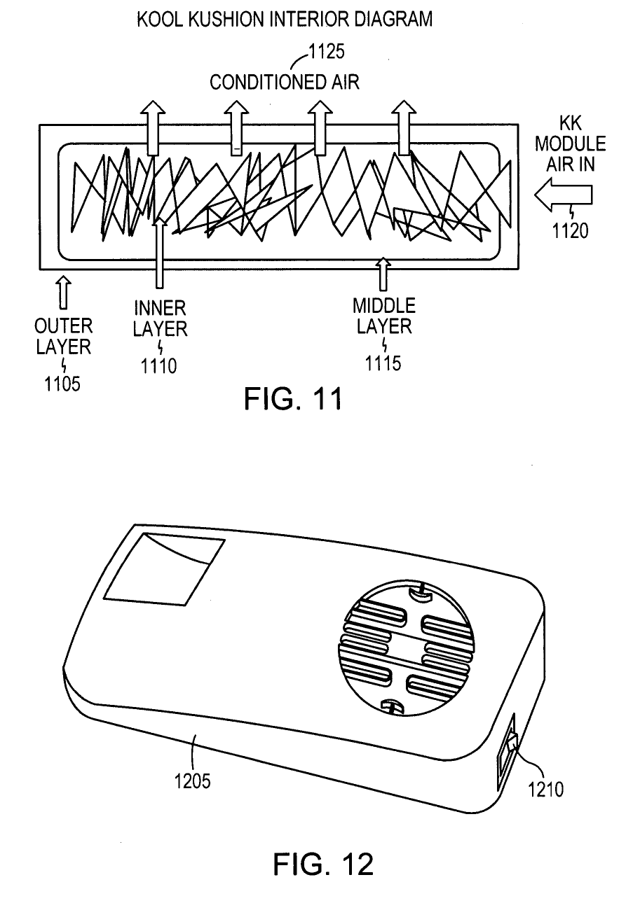

FIGS. 3 and 4 illustrate a Kool Kushion™ 305, 405 used in conjunction with the portable AC unit 310, 410 according to an example embodiment of the present invention. The Kool Kushion™ is a pet cushion adapted for use in a pet enclosure and is described below in further detail in conjunction with FIG. 11. The exhaust duct 320 of the portable AC unit 305, 405 may be coupled directly to the cushion 305, 405, via an inlet port 315.

Hence, in this configuration ambient air is drawn into the portable AC unit's 310 intake duct 325, heated or cooled as it flows past a thermoelectric module (not shown), exits the exhaust duct 320, and further flows to the cushion 305 where the conditioned air may exit a plurality of outlet openings 330 in the cushion. In an alternative embodiment, an air diffuser (not shown) may be coupled between the portable AC Unit's 310, 410 exhaust duct 320 and the cushion's 305, 405 inlet port 315 to allow for a variety of placement options of the portable AC unit 310, 410.

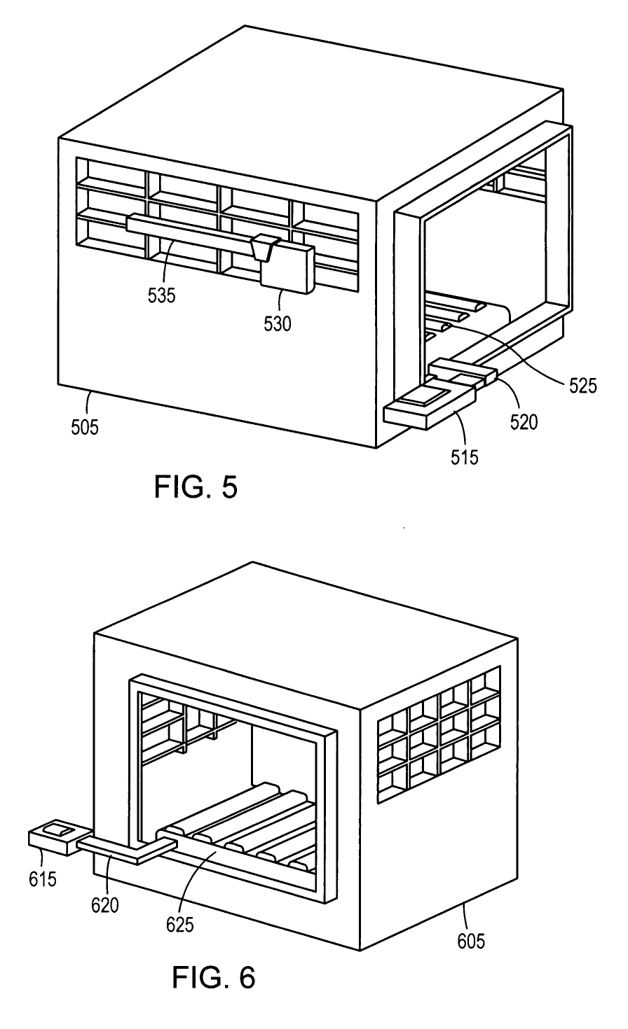

FIGS. 5 and 6 illustrate a pet enclosure 505, 605 employing example embodiments of the present invention. In one embodiment, a pet cushion 525, 625 is adapted for placement in the pet enclosure 505, 605 and the portable AC unit 515, 615 may be placed, for example, on the ground adjacent to the pet enclosure 505, 605. The portable AC unit 515, 615 may be connected directly to the cushion 525, 625 or alternatively, an air diffuser 520, 620 may be coupled between the portable AC unit 515, 615 and the pet cushion 525, 625.

The portable AC unit 530 and diffuser(s) 535 may have Velcro mounting strips or similar mechanical mounting technique (not shown) that may allow it to be attached to the ventilation/grating or similar attachment point of the pet enclosure 505 allowing the portable AC unit 530 to be attached to the pet enclosure 505 without complicated mounting procedures as shown in FIG. 5.

Thus, the portable AC unit 515, 530, 615, alone or optionally coupled to an air diffuser 535, comprise one embodiment whereby a complete air conditioning system may be attached to the pet enclosure or rested on the ground to provide conditioned air. In an alternative embodiment, the portable AC unit 515, 530, 615, pet cushion 525, 625, and optional air diffusers 520, 620 comprise a complete air conditioning system adapted for use with a cushion designed to fit within the pet enclosure 505, 605. In another embodiment, the portable AC unit 515, 530, 615 and cushion 525, 625 may be removed from the pet enclosure 505, 605 for use outside the pet enclosure to provide conditioned air in a manner similar to that described herein.

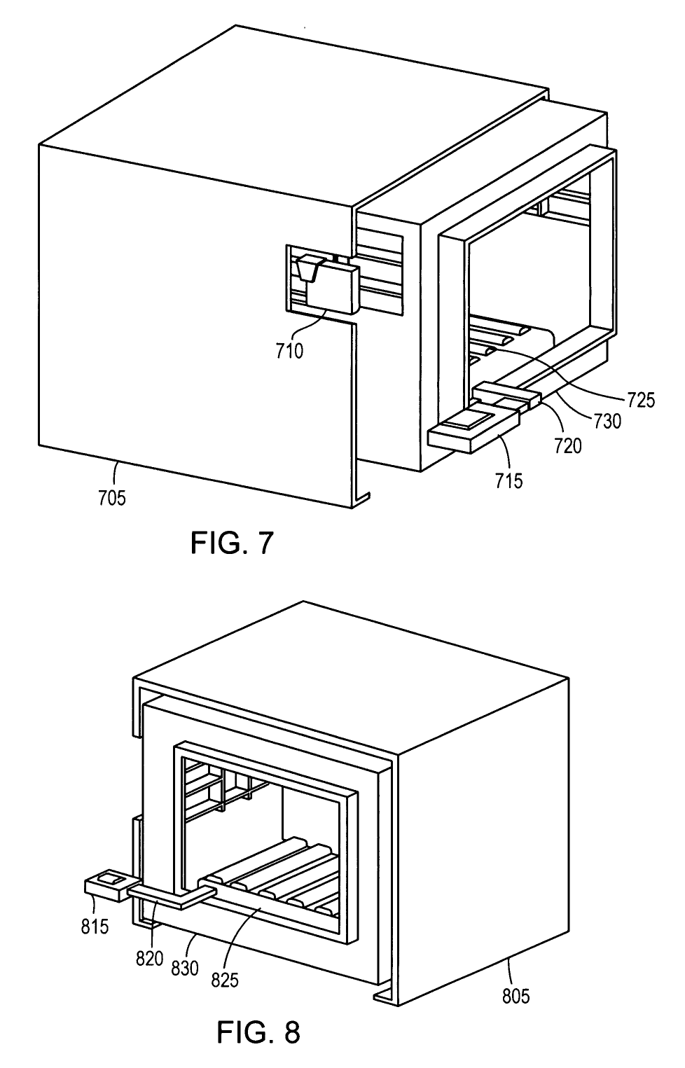

FIGS. 7 and 8 illustrate the use of a thermal insulating material 705, 805 used in conjunction with a pet enclosure 730, 830 employed with the present invention. In this embodiment, a pet cushion 725, 825 adapted for use with the portable air conditioning unit 715, 815 may be placed within the pet enclosure 730, 830. Alternatively, or in addition, a portable AC unit 710 may be mounted to the pet enclosure 730, 830 itself as was described above with reference to FIG. 5.

The thermal insulator and reflective covering 705, 805, such as an insulating blanket or other thermally resistant material may be adapted to substantially cover, for example, the top, sides, back, and optionally front or bottom surfaces of the enclosure 730, 830 to insulate the enclosure thereby reducing undesirable heat loss or gain. The covering 705, 805 may also reflect solar energy if the system is to be used outdoors. In one embodiment, the covering's outer layer may be made from a Scotchlite™ fabric and inner, crate side layer may be made of Thinsulate™ insulation. (Scotchlite™ and Thinsulate™ are registered trademarks of 3M Company, Minneapolis, Minn.)

Thus, the complete Kool Kennel™ and Kool Kushion™ system is easily mounted/hung/placed on the outside/inside of any cage, crate, or kennel, or other enclosure to provide air conditioning for the animal within the enclosure.

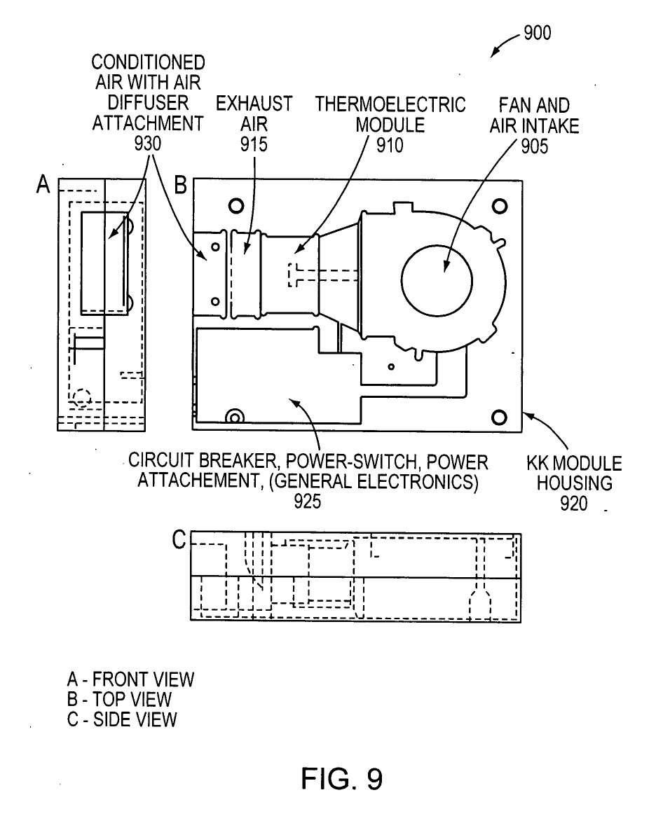

FIG. 9 is a mechanical drawing illustrating various components comprising a portable AC unit 900 according to an example embodiment of the present invention. The portable AC unit 900 may comprise a module housing 920 that includes a fan and air intake 905, thermoelectric module 910, exhaust air duct 915, attachment point for an air diffuser 930, and the unit's associated electronics 925 (e.g., circuit breaker, power switch, power attachment, temperature control, etc.). An air filter (not shown) may be provided, such as one coupled to the fan and air intake 905, and may be permanently mounted or easily replaced. In this embodiment, the fan may be used to draw ambient air into the air intake duct 905 and past the thermoelectric module 910 where the air is heated and cooled. The heated air then flows to the exhaust air vent 915 where it may, for example, exit the portable AC unit 900. The cooled air flows to the exhaust duct 930 where an air diffuser or cushion maybe coupled to further direct the conditioned air.

In an example embodiment, the portable AC unit's housing has a male/female (lock and key) slide-in diffuser connection as shown in FIGS. 2 and 9 (also made clear in FIGS. 5-8) which allows for the cooled/heated air to enter the enclosure in a user determined/prefabricated direction. The diffusers of various length and shape are made from the same material as the portable AC unit's housing (e.g., high strength plastic) which is molded to the forms shown. The diffusers hollow tube design is the male mate to the output of the portable AC unit to direct the conditioned air to a desired location or to a cushion. The portable AC unit's output (female connection) allows it to connect to various (male) air conditioned apparatuses as shown in FIGS. 1-8.

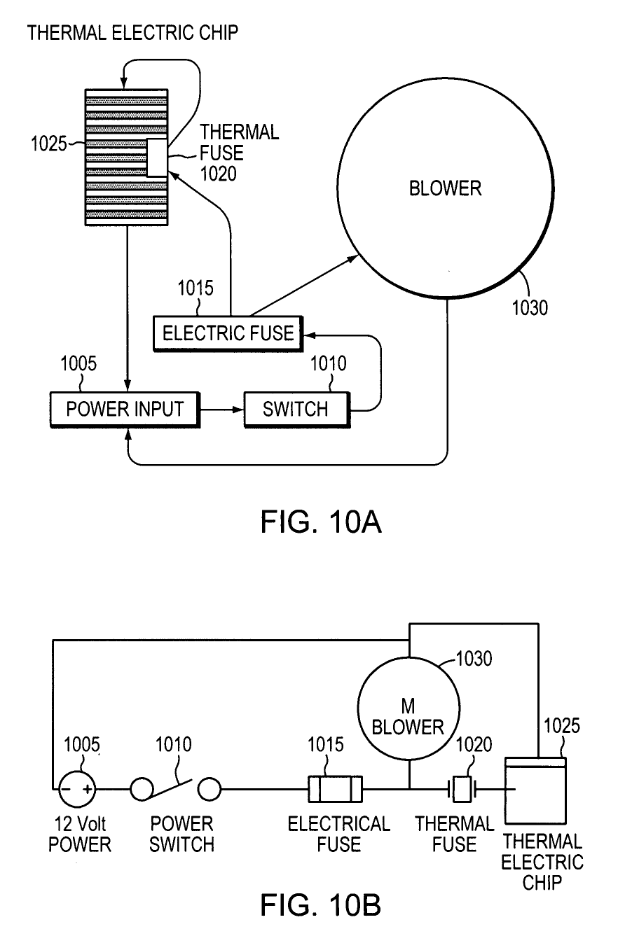

FIGS. 10A and 10B depict an electrical wiring diagram and schematic, respectively, of an example embodiment detailing the electrical components and corresponding connections used within a portable AC unit and includes a power source 1005, power switch 1010, electrical fuse 1015, thermal fuse 1020, thermoelectric module 1025, and blower/fan 1030.

In this embodiment, a terminal of the power supply 1005 (e.g., positive) may be coupled to a user controlled power switch 1010 for use in providing power to the circuit. The other side of the power switch 1010 may be coupled to the electrical fuse 1015 (optionally resettable). The other side of the electrical fuse 1015 may be coupled to the thermal fuse 1020 and the blower 1030. The thermal fuse 1020 may be used to prevent overheating. The other side of thermal fuse 1020 may then be connected to a thermoelectric module 1025. One example of a thermoelectric module 1025 is a thermoelectric module, part number # 144 manufactured by Ferrotec Corporation USA, 33 Constitution Drive Bedford, N.H. 03110. The other side of the thermoelectric module 1025 may be connected to the other side of the blower 1030 and the other power supply terminal (e.g., negative), thus, completing the circuit.

The portable AC unit's air conditioning mechanism is based on a thermoelectric module that employs the “Peltier” effect, such as that described in U.S. Pat. No. 6,410,971 B1, the entire teachings of which are incorporated herein by reference.

The thermoelectric module 1025 is a semiconductor-based electronic component that operates like a small heat pump. When a power supply 1005 is connected to a thermoelectric module, the resulting current flow through the thermoelectric module causes heat to move through the module from one side to the other. Therefore, one side of the thermoelectric module 1025 will be cooled while the opposite side simultaneously is heated. However, if the polarity of the power supply voltage 1005 is reversed such that current flows in the other direction heat will move through the thermoelectric device in the opposite direction. Thus, the direction of current flow can determine whether a particular side of the thermoelectric module effectively cools or warms ambient air. Consequently, the portable AC unit may be used for both heating and cooling applications.

The thermoelectric module 1025 may further include a copper heatsink (not shown) with protruding fins that is attached to one or both sides of the thermoelectric module 1025 such that the fins protrude into the air flow as the air is drawn from the input duct to the exhaust duct as shown in FIG. 9, for example.

In still another embodiment, the portable AC system (e.g., Kool Kennel™ and Kool Kushion™) may include a temperature control unit (not shown) providing the ability to monitor and adjust the temperature of air provided by the portable AC unit by, for example, adjusting the magnitude and/or direction of current flow through the thermoelectric module. The air conditioning system may comprise multiple cooling/heating units combined into a single housing to provide additional BTU cooling/heating capacity.

The Kool Kushion™ device's cushion is a soft pad made of three layers as shown in FIG. 11. The outer layer 1105 is composed of a porous and soft but rugged fabric. The inner layer 1110 is a plastic meshwork that resists compression and allows for the air from the portable AC unit to flow throughout the meshwork. The middle layer 1115 surrounds and seals the inner layer 1110 and controls the movement of thermally controlled air out pin holes in its walls and further out the outer layer 1105 providing conditioned air 1125 to the animal, even when the full weight of the pet is on the cushion, such as when the pet is sleeping or resting on the cushion.

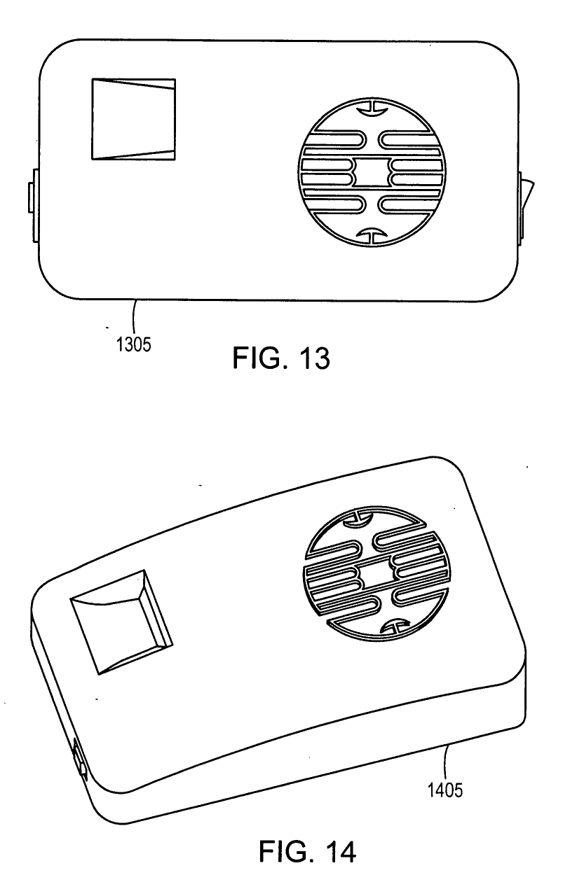

FIGS. 12, 13, and 14 illustrate an example embodiment of an alternative housing for the portable AC unit. In this embodiment, the unit portable AC unit may be used in conjunction with a cushion as described above. Alternatively, the unit may be used in a stand alone configuration where, for example, it may be attached to a pet enclosure (e.g., cage, crate, or kennel), on the ground, or some other support mechanism. In yet another example embodiment, the portable AC unit may be used in other confined environmental spaces such as an automobile, truck cabin, boat, small office or room, etc.

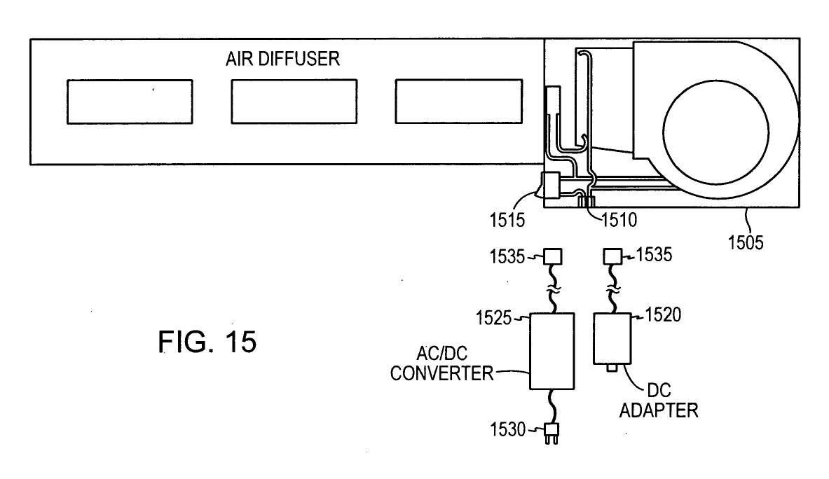

FIG. 15 is a block diagram illustrating different power supply sources for a portable AC unit 1505 according to an example embodiments of the present invention. In one embodiment, the portable AC unit 1505 is powered by a 12 volt (V) Direct Current (DC) power supply, such as an adaptor 1520 connected to an automobile power port. For example, power may be provided by an electrical connection from an adapter 1520 inserted into a cigarette lighter receptacle (not shown) where the adapter 1520 is wired to a connector 1535 which is further coupled to a mating connector 1510 on the portable AC unit 1505.

Alternatively, power may be supplied by an Alternating Current to Direct Current (AC/DC) converter 1525. Here, a standard plug 1530 may be plugged into a wall socket or similar outlet (not shown) that provides 110V or 220V. The outlet's output is converted to 12V DC via the AC/DC converter 1525 and further provided to the portable AC unit's 1505 mating connector 1510 via connector 1535. In other embodiments, the portable AC unit 1505 may be powered by a battery, solar, wind, or other similar power supply sources known in the art. Power to the portable AC unit 1505 may be controlled via an on-off switch 1515.

While this invention has been particularly shown and described with references to example embodiments thereof, it will be understood by those skilled in the art that various changes in form and details may be made therein without departing from the scope of the invention encompassed by the appended claims.

What is claimed is:

1. An apparatus to provide conditioned air comprising:
an enclosure adapted to house a pet;
a cushion including a ventilation layer within a substantially air-tight compartment having an inlet port for accepting airflow into the ventilation layer and a plurality of outlet openings for exhausting conditioned air to the cushion surface, the cushion disposed in base of the enclosure;
a portable air conditioning unit comprising an air intake duct, a thermoelectric module, an exhaust duct, and a fan positioned to move air from the intake duct, across the thermoelectric module, and out the exhaust duct;
a power supply unit configured to provide power to the thermoelectric module and the fan; and
an air diffuser coupled between the exhaust duct and the cushion inlet port such that conditioned air is delivered to the plurality of outlet openings.
